(19) United States
(12) Patent Application Publication
(10) Pub. No.: US 2024/0184156 A1
(43) Pub. Date: Jun. 6, 2024

(54) ALIGNED POLYMER DISPERSED LIQUID CRYSTAL FILM FOR LIGHT ENHANCEMENT OF QUANTUM DOT BACKLIGHT

(71) Applicant: KENT STATE UNIVERSITY, Kent, OH (US)

(72) Inventors: Deng-Ke Yang, Hudson, OH (US); Suman Halder, Kent, OH (US)

(73) Assignee: KENT STATE UNIVERSITY, Kent, OH (US)

(21) Appl. No.: 18/527,604

(22) Filed: Dec. 4, 2023

Related U.S. Application Data
(60) Provisional application No. 63/429,600, filed on Dec. 2, 2022.

(51) Int. Cl. G02F 1/1334; G02F 1/13357

(52) U.S. Cl. CPC G02F 1/1334; G02F 1/133617

(57) ABSTRACT

An aligned polymer dispersed liquid crystal film is useful for enhancing light efficiency of a quantum dot backlight. The film may be formed by a process including irradiating a mixture with UV light at a first intensity to form a first composition comprising an isotropic polymer matrix; and irradiating the first composition with UV light at a second intensity to form a second composition comprising an anisotropic polymer network. The mixture includes an isotropic monomer; a mesogenic monomer; photo-initiator and a liquid crystal.

This application claims the benefit of U.S. Provisional Application No. 63/429,600 filed Dec. 2, 2022, and titled “ALIGNED POLYMER DISPERSED LIQUID CRYSTAL FILM FOR LIGHT ENHANCEMENT OF QUANTUM DOT BACKLIGHT,” which is hereby incorporated by reference in its entirety.

### BACKGROUND

Liquid crystal displays (LCDs) are the leading flat panel display technology, in part due to advantages such as high resolution, being lightweight, having low manufacturing cost, and having long service life. The liquid crystal layer in the displays does not emit light. A light source, such as a backlight or edge light, provides light. The liquid crystal, controlled by applied voltages, modulates the outgoing light intensity with the help of polarizers. Typically, white or color light emitting diodes (LEDs) are usually used as the backlight (or edge light). Colored images are displayed with the help of red, green, and blue color filters. There are two major problems with the color filters. First, color filters absorb light, resulting in low light efficiency. Second, their transmission bandwidths are not narrow, resulting in a small color gamut.

Quantum dots (QDs) have been used to make backlights, which provide a superior color gamut, for liquid crystal flat panel displays. QDs are nano-sized semiconductor crystals that emit colored light (red, green, and blue) under UV (or blue) light irradiation. The emitted colored lights have narrow bandwidths. When a QD backlight is used to illuminate LCDs, it can greatly improve the color gamut of the displays. In a QD backlight, QDs are dispersed in a polymer film. When the QDs are illuminated by UV (or blue light), they absorb the short wavelength light and emit longer wavelength light in all directions through photoluminescence. Some light is emitted in directions with small incident angles; it is refracted at the polymer-air interface and comes out of the film. Some light is emitted in directions with large incident angles, and it is totally internally reflected back at the polymer-air interface and then waveguided through the film. It is either absorbed when waveguided through the film or comes out at the edge of the film and, therefore, it is wasted.

A problem with the system is that most of the emitted light cannot exit the film due to the total internal reflection at the film-air interface and is wasted. Accordingly, it would be desirable to develop new devices in which the total internal reflection in the QD backlight is reduced and thus light efficiency is improved.

### BRIEF DESCRIPTION

Disclosed, in some embodiments, is an aligned polymer dispersed liquid crystal film including: a polymer matrix; and uniformly aligned liquid crystal droplets dispersed in the polymer matrix.

Disclosed, in other embodiments, is a method of forming an aligned polymer dispersed liquid crystal film. The method includes irradiating a mixture with UV light at a first intensity to form a first composition comprising an isotropic polymer matrix; and irradiating the first composition with UV light at a second intensity to form a second composition comprising an anisotropic polymer network. The second intensity optionally exceeds the first intensity. The mixture includes: an isotropic monomer; a mesogenic monomer; and a liquid crystal.

In some embodiments, the mixture further contains a photoinitiator.

In some embodiments, no voltage is applied when the mixture is irradiated with UV light at the first intensity; and a curing voltage is applied when the first composition is irradiated with UV light at the second intensity.

The first intensity may be in a range of about 0.1 to 10 mW/cm², including about 0.5 to about 2.5 mW/cm², about 0.75 to about 1.75 mW/cm², about 1.0 to about 1.5 mW/cm², about 1.1 to about 1.4 mW/cm², about 1.2 to about 1.3 mW/cm², and about 1.25 mW/cm².

In some embodiments, the curing voltage is at least 5 V, at least 10 V, at least 20 V, or at least 25 V.

The curing voltage may be in a range of about 5 to about 150 V or about 25 V to about 150 V.

In some embodiments, mesogenic monomer is present in the mixture in an amount of at least 1.5 wt %, at least 2.0 wt %, or at least 2.5 wt %.

The mesogenic monomer may present in the mixture in an amount of about 0.5 to about 5 wt % or about 2.5 to about 5 wt %.

Disclosed, in further embodiments, is a device including: a quantum dot backlight; and an aligned polymer dispersed liquid crystal film.

The aligned polymer dispersed liquid crystal film may include: a first material comprising a polymer having a refractive index nₚ; and a plurality of droplets comprising liquid crystals disposed within the first material, the liquid crystals having an ordinary refractive index nₒ and an extraordinary refractive index nₑ.

In some embodiments, nₑ is at least about 1.7.

nₑ may be in the range of from about 1.6 to about 1.8.

In some embodiments, nₚ is in the range of from about 1.5 to about 1.6.

nₒ may be within about 0.05 of nₚ.

In some embodiments, the film has thickness of from about 1 μm to about 500 um, about 5 μm to about 400 μm, or about 10 μm to about 50 μm.

The quantum dot backlight may include a quantum dot film optically coupled to the aligned polymer dispersed liquid crystal film.

Disclosed, in additional embodiments, is a method of forming an electronic device. The method includes forming an aligned polymer dispersed liquid crystal film; and laminating the aligned polymer dispersed liquid crystal layer to a quantum dot backlight.

The forming includes: irradiating a mixture with UV light at a first intensity to form a first composition comprising an isotropic polymer matrix; and irradiating the first composition with UV light at a second intensity to form a second composition comprising an anisotropic polymer network. The mixture contains an isotropic monomer; a mesogenic monomer; and a liquid crystal. The second intensity optionally exceeds the first intensity.

These and other non-limiting characteristics are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a schematic diagram of a quantum dot backlight.

FIG. 2 is a schematic diagram of a quantum dot backlight including an aligned polymer dispersed liquid crystal film in accordance with some embodiments of the present disclosure.

FIG. 3 is a graph illustrating emitted light intensity versus emission angle of QD backlights described in the Examples (a) with an aligned polymer dispersed liquid crystal film and (b) without an aligned polymer dispersed liquid crystal film.

### DETAILED DESCRIPTION

The present disclosure may be understood more readily by reference to the following detailed description of desired embodiments included therein. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety except for any definitions, disclaimers, disavowals, and inconsistencies. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

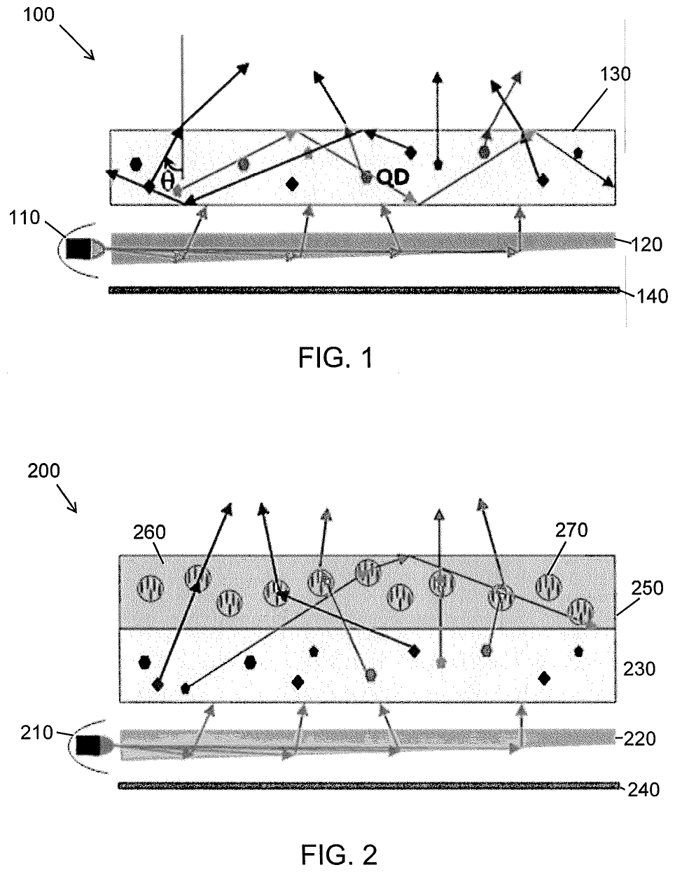

The structure of a non-limiting embodiment of a QD backlight is schematically illustrated in FIG. 1. A light source (such as a LED, e.g., a blue LED) 110 is installed on the edge of the system 100. The light produced by the LED is coupled to a light waveguide plate 120 and is waveguided through the plate. The plate has scattering centers (dispersed particles or punched holes). When the incident light encounters a scattering center, it is scattered and enters the QD film 130. When the entered light is absorbed by a QD, an electron is excited from the valence band to the conduction band, producing a pair of an electron and a hole. When the electron and hole recombine, light is emitted. Due to the confinement of the electron in the QD, the emitted light has a very pure color (e.g., with a wavelength bandwidth of 10 nm). Thus, when the QD backlight is used to illuminate LCDs, a large color gamut is achieved. The system can also include a reflector 140.

The QDs emit light in all directions. The direction of an emitted light can be specified by the incident angle, θ, which is defined with respect to the normal of the QD film, as shown in FIG. 1. Not all the emitted light rays can exit the QD film, depending on their incident angles. If the incident angle is small, the emitted light refracts at the film-air interface and comes out of the side toward the functional liquid crystal layer (which displays images and is not shown in the figure). If the incident angle is larger than a critical angle, θ_{c}, it is totally internally reflected back. Then, it is waveguided through the film and does not come out of the side toward the functional liquid crystal layer and, therefore, is not utilized. The refractive index of the polymer in the QD film is usually about 1.5. The refractive index of air is about 1.0. Therefore, the critical angle equals θ_{c}=arcsin(1.0/1.5)=42°.

It has been found that including an aligned polymer dispersed liquid crystal (APDLC) film enhances the light efficiency of the QD backlight. Polymer dispersed liquid crystals (PDLCs) are composites containing isotropic polymer and liquid crystals and have been used to make switchable windows for privacy control, flat panel displays, and projection displays. In a regular PDLC film, a liquid crystal forms micron-sized droplets, which are dispersed in an isotropic polymer. The refractive index of the polymer is matched to the ordinary refractive index of the liquid crystal but smaller than the extraordinary refractive index of the liquid crystal. Inside a droplet, the liquid crystal molecules are more or less aligned along a common direction known as the droplet direction. When no external electric field is applied, the droplet direction is, however, random throughout the film. For an incident light, independent of its propagation direction, it encounters different refractive indices in the polymer and liquid crystal droplet and thus is scattered. When a sufficiently high voltage is applied across the film, the droplets are aligned along with the film's normal direction.

As mentioned above, one way to align the liquid crystal droplet in the film's normal direction is to apply a voltage across the film. This way is, however, troublesome because it requires a voltage source and consumes energy.

The structure of a non-limiting embodiment of a QD backlight with an APDLC film is schematically illustrated in FIG. 2. The system 200 includes a blue LED 210, a light waveguide plate 220, a QD film 230, and may further include a reflector 240. The APDLC film 250 includes a polymer film 260 with dispersed liquid crystal droplets 270. The liquid crystal molecules in the droplets are uniformly aligned in the normal direction of the film. The liquid crystal has an anisotropic optical property that exhibits an ordinary refractive index, nₒ, for light polarized perpendicular to the long axis of the molecule and an extraordinary refractive index, nₑ, for light polarized parallel to the long molecular axis. The polymer is optically isotropic and has a refractive index, nₚ, which is chosen to approximately equal nₒ. The APDLC film is applied (e.g., laminated) on top of the QD film, optionally with the help of an optical adhesive. The refractive indices of the polymers in the QD film and APDLC film, as well as that of the adhesive, may be about the same. There is no refraction and reflection at the interface between them. For emitted light with zero or small incident angles, when it propagates through the APDLC film, it encounters a similar refractive index in both the polymer and the liquid crystal, and thus is not scattered. Its incident angle with respect to the film's normal does not change much, and it comes out of the side toward the functional liquid crystal layer. Emitted light with large incident angles encounters different refractive indices in the polymer and liquid crystal when it propagates through the APDLC film. Thus, it is scattered. When it is scattered into directions with a small incident angle, it comes out of the side toward the functional liquid crystal layer. Therefore, the APDLC film can enhance the light efficiency of the QD backlight.

It should be understood that other layers may be included. Moreover, the type and location of the light source may be varied.

The APDLC film may be made from a mixture containing isotropic monomers (or prepolymers), mesogenic (anisotropic) monomers, and a nematic liquid crystal. The mixture may further include a photo-initiator in some embodiments. The APDLC film may be fabricated using the following steps.

In step 1, the mixture is made into a film. In some embodiments, the mixture is homogenized prior to film-forming.

In step 2, the isotropic monomers are polymerized and phase separate from the liquid crystal and anisotropic monomers. The liquid crystal and anisotropic monomers form micron-sized droplets, which are dispersed in the polymer formed by the isotropic monomers. The droplets are aligned in the film's normal direction, namely in the direction perpendicular to the film, by externally applied fields, such as electric and magnetic fields.

In step 3, the anisotropic monomers are polymerized to form a polymer network, which keeps the droplets aligned in the film's normal direction when the externally applied field is removed. Note that the external field may be applied when the isotropic monomers are polymerized in step 2. Also, note that some of the anisotropic monomers may be polymerized in step 2. The mixture may further include a photo-initiator in some embodiments.

The APDLC film may contain from about 10 wt % to about 90 wt % of polymer, including from about 10 wt % to about 80 wt % and from about 40 wt % to about 60 wt %.

The APDLC film may contain from about 10 wt % to about 90 wt % of anisotropic material (e.g., liquid crystal), including from about 10 wt % to about 80 wt % and from about 40 wt % to about 60 wt %.

The APDLC film may have a thickness of from about 1 μm to about 500 μm, including from about 5 μm to about 400 μm and from about 10 μm to about 50 μm.

The liquid crystals may have an ordinary refractive index within about 0.1 of the refractive index of the polymer, and an extraordinary refractive index that is larger than the refractive index of the polymer. A larger difference between the extraordinary refractive index and the refractive index of the host material may be preferred. In some embodiments, the extraordinary refractive index may be in the range of about 1.6 to 1.8, and preferably may be at least 1.7. The refractive index of the host material may be in the range of about 1.5 to 1.6.

The APDLC film of the present disclosure may also be used to increase the light efficiency of other flat panel displays, such as organic light-emitting diode (OLED) displays and micro light-emitting diode (MLED) displays.

Devices fabricated in accordance with embodiments of the present disclosure may be incorporated into a wide variety of consumer products, including flat panel displays, computer monitors, medical monitors, televisions, billboards, lights for interior or exterior illumination and/or signaling, heads up displays, fully transparent displays, flexible displays, laser printers, telephones, cell phones, personal digital assistants (PDAs), laptop computers, digital cameras, camcorders, viewfinders, micro-displays, 3-D displays, vehicles, a large area wall, theater or stadium screen, or a sign. Various control mechanisms may be used to control devices fabricated in accordance with the present disclosure, including passive matrix and active matrix. Many of the devices are intended for use in a temperature range comfortable to humans, such as 18° C. to 30° C., and more preferably at room temperature (20-25° C.), but could be used outside this temperature range, for example, from −40° C. to +80° C.

The materials and structures described herein may have applications in devices other than those specifically described herein. For example, other optoelectronic devices such as organic solar cells and organic photodetectors may employ the materials and structures. More generally, organic devices, such as organic transistors, may employ the materials and structures.

Non-limiting examples of quantum dot backlight structures are disclosed in U.S. Pat. Nos. 9,618,681; 9,897,737; 10,088,132; 10,177,485; 10,914,886, 10,976,600, 10,988,619, 11,043,618, 11,150,509, 11,520,180, 11,653,513, 11,740,489, 11,803,079, 11,822,098; U.S. Pub. Nos. 2018/0106,938, 2021/0124098, 2021/0381676, 2022/0310885, 2022/0373837, 2023/0043944, 2023/0141990, 2023/0350123; and PCT Pub. Nos. WO2017/156902; 2019/007296; and 2020/25876. These documents are incorporated by reference herein in their entireties except for any definitions, disclaimers, disavowals, and inconsistencies. It should be understood that the APDLC films of the present disclosure may be used with the quantum dot backlight structures of any of these documents and/or other quantum dot backlight structures that are known in the art.

The following examples are provided to illustrate the devices and methods of the present disclosure. The examples are merely illustrative and are not intended to limit the disclosure to the materials, conditions, or process parameters set forth therein.

### EXAMPLES

A mixture was provided including 54.4 wt. % isotropic prepolymer NOA65 (from Norland Optical Adhesive Inc.), 2.5 wt. % anisotropic monomer RM257 (from Merck), 42.6 wt. % nematic liquid crystal E7 (from Merck), and 0.5 wt. % photo-initiator benzoin methyl ether (from PolyScience Inc.). NOA65 is a mixture of acrylate flexible monomers and oligomers. E7 has a positive dielectric anisotropy of +13.8, and the molecules align parallel to the applied electric field. RM257 is a bifunctional mesogenic monomer that forms an anisotropic polymer network when polymerized.

In the fabrication of the APDLC film, in step 1, the mixture is sandwiched between two indium-tin-oxide (ITO)-coated polyethylene terephthalate (PET) films. The APDLC film thickness is controlled by 30 μm spacers. In step 2, the film is irradiated by UV light of an intensity of 1.25 mW/cm² for 1 minute. In step 3, an AC voltage of 100 V is applied across the film, and the film is irradiated by UV light of an intensity of 2.5 mW/cm² for 30 minutes.

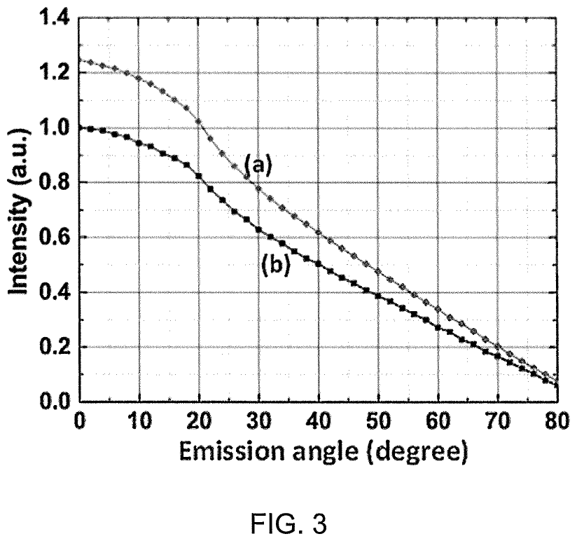

The APDLC film is laminated on top of a QD backlight (from BOE Technology Co., Ltd.). The emitted light intensity as a function of the emission angle of the QD backlight with the APDLC film is shown by curve (a) in FIG. 3 For comparison, the emitted light intensity as a function of the emission angle of the QD backlight without the APDLC film is shown by curve (b) in FIG. 3. When the APDLC film is added, the emitted light intensity at all emission angles is increased. The total emitted light intensity, namely the light emitted in all angles, is increased by 20%.

Additional examples and figures are provided in the article provided herewith. These examples and figures as well as the remainder of the article are part of this application.

The effects of UV light intensity on the optical properties of the APDLCs were investigated. The UV light intensity in the first step was varied, as shown in Table 1. The UV light intensity in the second step was fixed at 2.5 mW/cm². The curing voltage in the second step was 100 V. The transmittances of the aligned PDLCs at 0 V are much higher than unaligned PDLCs because the LC droplets are partially or well aligned along the film's normal direction due to the curing voltage and the polymer network formed in the second step. The transmittances of the samples at 0 V are listed in Table 1. The maximum transmittance is obtained at the intermediate UV light intensity of 1.25 mW/cm². The effects of the UV light intensity in the first step on the transmittance at 0 V are realized through three aspects. The first aspect is the LC droplet size. The higher the UV light intensity, the droplets with smaller sizes are formed. In the absence of applied voltage, there are two factors affecting the direction of the droplet: anchoring of polymer at the droplet surface and aligning effect of the polymer network. The anchoring tends to align the droplet randomly, and its effect is stronger in smaller droplets. The polymer network tends to align the droplet in the film's normal direction. The second aspect is the amount of unpolymerized mesogenic monomers (RM257) after the first step. In the first step, some of the mesogenic monomers are polymerized. The higher the UV light intensity, the fewer mesogenic monomers are unpolymerized and the polymer network formed in the second step is weaker. The third aspect is the amount of unpolymerized isotropic monomers (NOA65) after the first step. The unpolymerized isotropic monomers are polymerized in the second step to form isotropic beads, which tend to randomize the direction of the LC droplets. With the higher UV light intensity in the first step, the fewer isotropic monomers are unpolymerized, and the isotropic beads formed in the second step have a weaker randomizing effect. Under the overall effects of the three aspects, better aligned LC droplets are formed under intermediate UV light intensity in the first step.

TABLE 1
Transmittance of APDLCs at 0 V vs. UV light
intensity in the first step of polymerization

| Sample # | A1 | A2 | A3 | A4 | A5 | A6 | A7 |
|---|---|---|---|---|---|---|---|
| UV Intensity | 0.5 | 0.75 | 1.0 | 1.25 | 1.5 | 1.75 | 2.5 |
| (mW/cm²) | | | | | | | |
| Transmittance | 61% | 64% | 72% | 75% | 68% | 62% | 39% |
| at 0 V | | | | | | | |

The transmittance of the APDLCs increases with the applied voltage in the measurement. As the UV light intensity in the first step is increased, the driving voltage (the saturation voltage to obtain the maximum transmittance) increases. Under higher UV light intensity in the first step, smaller LC droplets form, where the surface anchoring effect is stronger and the aligning effect of the anisotropic polymer network is weaker, and therefore a higher voltage is needed to align the LC droplets. Another effect of the UV light intensity is on the maximum transmittance (the saturated transmittance at the saturated voltage). As the UV light intensity in the first step is increased, the maximum transmittance increases. This is probably because after the first step, the amount of unpolymerized isotropic monomers decreases, and therefore there are fewer isotropic polymer beads inside the LC droplets. The maximum transmittance of sample A4 is about 83%. The light loss is 17%. The reflection from the glass-air, glass-ITO, and ITO-polymer interfaces causes about 10% light loss. Non-perfect match between the reactive indices of the polymer and liquid crystal is responsible for the rest of the light loss.

The effects of UV light intensity in the second step on the optical properties of the APDLCs was also examined. The UV light intensity in the first step was fixed at 1.25 mW/cm². The UV light intensity in the second step was varied, as shown in Table 2. The curing voltage in the second step was 100 V. The transmittance at 0 V increases slightly with the UV light intensity in the second step, as listed in Table 2. The transmittance increases with increasing applied voltage. The driving voltage and maximum transmittance are almost independent of the UV intensity. As mentioned above, there are three aspects that affect the electro-optical properties of the APDLCs. Once the UV light intensity in the first step is fixed, all the three aspects (the LC droplet size, the amount of unpolymerized mesogenic monomers, and the amount of unpolymerized isotropic monomers) are fixed. Therefore, the electro-optical properties are almost fixed. The only effect of the UV light intensity in the second step is on the anisotropic polymer network formed in the second step. When the UV light intensity is increased, a denser and smaller lateral sized network forms, which has a stronger aligning effect on the LC. Therefore, the LC droplets are aligned better in the film's normal direction, and the transmittance at 0 V is increased.

TABLE 2
Transmittance of APDLCs at 0 V vs. UV light intensity
in the second step of polymerization

| Sample # | B1 | B2 | B3 | B4 |
|---|---|---|---|---|
| UV intensity | 1.5 | 2.0 | 2.5 | 3.0 |
| (mW/cm²) | | | | |
| Transmittance | 72% | 74% | 75% | 75% |
| at 0 V | | | | |

In order to keep the LC droplets in the film's normal direction, the polymer network is in the film's normal direction. In order to achieve this goal, the curing voltage in the second step may be controlled. The curing voltage in the second step was examined. The UV light intensity in the first and second steps were 1.25 mW/cm² and 2.5 mW/cm², respectively. The transmittances at 0 V of the samples cured under various curing voltages are listed in Table 3. When the curing voltage in the second step is 0V, the transmittance is very low, about 2%, because the direction of the LC droplets is random throughout the sample, as in regular PDLCs. As the applied voltage in the curing is increased, the transmittance at 0 V increases. When the curing voltage is increased to 100 V, the transmittance saturates at 75%. For the sample cured under 0 V, the transmittance increases dramatically with the applied voltage. For the samples cured at voltages higher than 25 V, the transmittance increases slightly with the applied voltage. One interesting point is that the sample cured under 25 V has the transmittance of 67% at 0 V, while the sample cured at 0 V has the transmittance of 4% when the applied voltage is 20 V. These different transmittances are caused by the polymer network in the LC droplets. Without the polymer network, the voltage needed to align the LC droplets is about 30 V. If a sufficiently high curing voltage is applied in the second step, the LC droplets are aligned along with the film's normal, and then the polymer network is formed in the film's normal direction, which will keep the droplets in the aligned state when the applied voltage is removed. If no curing voltage is applied in the second step, the directions of the LC droplets are random, and then the polymer network is formed in random directions. When the voltage is removed, the polymer network will try to keep the LC droplets in the random state. After the curing, in order to overcome the aligning effect of the polymer network, 100 V, much higher than 30 V, is needed to align the LC droplet.

The anisotropic polymer network is critical to keep the LC droplets aligned in the film's normal direction after curing. The effects of the polymer network were studied by varying the mesogenic monomer (RM257) concentration. The UV light intensity in the first step and second steps were 1.25 mW/cm² and 2.5 mW/cm², respectively. The curing voltage in the second step was 100 V.

TABLE 3
Transmittance of APDLCs at 0 V vs. applied voltage
in the second step of polymerization

| Sample # | C1 | C2 | C3 | C4 | C5 |
|---|---|---|---|---|---|
| Curing | 0 | 25 | 50 | 100 | 150 |
| Voltage (V) | | | | | |
| Transmittance | 2% | 67% | 73% | 75% | 75% |
| at 0 V | | | | | |

The transmittances at 0 V of the samples with various concentrations of RM257 are listed in Table 4. When the mesogenic monomer is 0%, the transmittance is very low, about 3%, because there is no anisotropic polymer network. Although the LC droplets are aligned in the film's normal direction during the curing, they relax back to the random state when the curing voltage is removed. As the mesogenic monomer concentration is increased, a more dense polymer network is formed, which has a stronger aligning effect on the LC. When the concentration is below 2.5%, the polymer network is not strong enough to keep the LC droplets in the state aligned by the curing voltage in the second step. After the curing, when the curing voltage is removed, the LC droplets relax some from the well aligned state, and the transmittance becomes lower than the maximum transmittance. When the concentration is above 2.5%, the polymer network is strong enough to keep the LC droplets in the state aligned by the curing voltage. After the curing, when the curing voltage is removed, the LC droplets remain in the well aligned state, and the transmittance remains at the maximum value. For the sample with 0% mesogenic monomer, at 0 V, its transmittance is very low, about 3%. As the applied voltage is increased, its transmittance increases. The driving voltage is about 30 V, at which the maximum transmittance of about 80% is reached. This driving voltage is lower than that (100 V) of the sample (C1) with 2.5% mesogenic monomer but cured at 0V, where there is the polymer network which has an aligning effect on the LC against the aligning effect of the applied voltage. Note that when the applied voltage is 20 V, the transmittance is 65%, which is the same as that of the sample (C2) with 2.5% mesogenic monomer and cured at 20 V. When the mesogenic monomer concentration is higher than 2.5%, the formed polymer network is strong enough to keep the LC droplets in the well aligned state. After curing, the transmittance is high and does not change much with the applied voltage.

TABLE 4
Transmittance of APDLCs at 0 V vs. the
concentration of the mesogenic monomer.

| Sample # | D1 | D2 | D3 | D4 | D5 | D6 | D7 | D8 |
|---|---|---|---|---|---|---|---|---|
| Mesogenic | 0% | 0.5% | 1.5% | 2.0% | 2.5% | 3.0% | 3.5% | 4.5% |
| monomer | | | | | | | | |
| concentration | | | | | | | | |
| Transmittance | 3% | 12% | 48% | 70% | 75% | 75% | 74% | 75% |
| at 0 V | | | | | | | | |

The morphology of the APDLCs was examined under a polarizing optical microscope with crossed polarizers. If the UV light intensity in the first step is higher than 1 mW/cm², the LC droplet size is about 1 micron. Under the optical microscope, it is very difficult to study the textures of droplets of that size. Therefore, UV light with very low intensity (0.05 mW/cm²) was used to prepare unaligned and aligned PDLCs with large droplet sizes. When the samples were studied under the microscope, there was no applied voltage. The droplet size is around 3 μm. The droplets have the typical texture of bipolar droplets, indicating that the LC orients tangentially on the polymer surface of the droplet. The textures of the LC droplets are different from one another, indicating that the bipolar axis of the droplets is random throughout the sample The textures of the LC droplets are more or less the same. The texture has two dark crossed brushes, indicating the bipolar axis is aligned in the film's normal direction. The aligned PDLC droplet exhibits small birefringence; therefore, the texture is less colorful than that of the unaligned PDLC droplet. The incomplete black texture indicates that the LC is not perfectly aligned along the film normal direction. Therefore, it still exhibits some weak scattering and causes some light loss.

It is impossible to observe the polymer network inside the LC droplet under the optical microscope because of its limited resolution. Therefore, a scanning electron microscope (SEM) was used to study the polymer network. The samples were cured under UV light with very low intensity (0.05 mW/cm²). In the preparation of the samples for the SEM study, the samples were frozen, and then were broken into small pieces. Then samples were immersed in hexane for 1.5 minutes to dissolve the LC, but not the isotropic polymer and the anisotropic polymer network. After that, samples were placed in a thermal oven at 70° C. for 2 hours to evaporate the solvent. Subsequently, they were coated with a thin layer of gold by spattering. The relatively bright region is the isotropic polymer. The relatively dark regions are the voids which were occupied by the LC droplets before removal. There is nothing inside the voids. In some voids, there are polymer networks in the film's normal direction. In the other voids, no polymer network is observed, probably because the polymer network is very thin and dissolved by the solvent in the preparation of the sample for SEM study.

The different transmittances of the unaligned and aligned PDLCs can be seen visually. Photographs of the PDLC samples under room light illumination were taken. A paper with the letters “KSU” is placed 5 cm beneath the samples. The unaligned PDLC sample at 0 V is very scattering and has an opaque white appearance. The paper beneath it cannot be seen. When 100 V is applied, it becomes transparent, and the letters “KSU” can be seen. The aligned PDLC sample at 0 V is transparent (with the transmittance of 75%), and the letters “KSU” can be seen. When 100 V is applied, it becomes more transparent (with the transmittance of 83%), the letters “KSU” appear clearer.

In order to demonstrate the selective scattering of the aligned PDLC, the transmittance of the PDLC sample was measured as a function of incident light angle. In order to eliminate the factor of the variation of the reflection from the substrate-air interfaces with the incident light angle a, the sample is placed in a cylinder with a refractive index matching oil of the refractive index of 1.5. The aligned PDLC sample does not scatter normally incident light. Its transmittance is high (75%) for incident light with 0° incident angle. As the incident angle is increased, it gradually becomes scattering, and its transmittance decreases. When the incident angle is 60°, its transmittance decreases to 10%. For comparison, the transmittance of the unaligned PDLC sample was also measured at various incident angles. It is very scattering for light with any incident angle, and its transmittance is always low.

Aligned PDLC films were used to enhance the light efficiency of the QD backlight. In the experiment, the QD backlight was provided by BOE Technology Co., Ltd. The substrate used to make the PDLC films is a polyethylene terephthalate (PET) film with ITO coating. The fabricated PDLC film was laminated on the top of the QD backlight with the help of a refractive index matching oil. The emitted light intensity was measured as a function of the emission angle, β. The light intensity at 0° emission angle is normalized to 1. In order to make the light enhancing effect of the aligned PDLC films stand out, the light enhancing effect of unaligned PDLC films was measured. All the PDLC films, independent of whether aligned or not, increase the light output. The incorporation of the PDLC films increases the light intensity but does not change the shape of light intensity vs. emission angle curve. There are two important features worth pointing out. First, the light enhancing effect of aligned PDLC films (cured at 100 V) is significantly higher than the unaligned PDLC films (cured at 0 V). Second, the light enhancing effect increases with the PDLC film thickness. When the film thickness is increased, its scattering capability increases, and more light emitted in large incident angles is scattered toward the film's normal direction.

As mentioned before, the LC droplets at 0 V are not perfectly aligned because the transmittance of the aligned PDLC at 0 V is about 75% and can be increased further with applied voltages. 100 V was applied to the PDLC films and measured the emitted light intensity. For the unaligned PDLC films, the light intensity is increased significantly by the applied voltage in the measurement, while for the aligned PDLC films, the light intensity is increased slightly by the applied voltage. From the measured function I(β) of light intensity I vs. emission angle β, the total emitted light intensity was calculated by using the equation

$${I}_{total} = {\int }_{0}^{π / 2} I ( β ) sin β d β . \qquad ( 1 )$$

The total emitted light intensities of the QD backlight enhanced by the PDLC films are listed in Table 5. The light enhancement efficiency of the unaligned PDLC at 0 V is only 5.6%. The light enhancement efficiency of the 20 μm aligned PDLC at 0 V is only 17.1%. When the film thickness is increased to 30 μm, the light enhancing efficiency is increased to 21.6%.

TABLE 5
Total light intensity of the QD backlight enhancement
by unaligned and aligned PDLC films.

| | | | Total Light | |
|---|---|---|---|---|
| PDLC Film | Curing | Measuring | Intensity | Enhancement |
| Thickness | Voltage (V) | Voltage (V) | (a.u.) | (%) |
| 0 (without | | | 9.2 | |
| PDLC Film) | | | | |
| 20 μm | 0 | 0 | 9.7 | 5.6 |
| | 0 | 100 | 10.7 | 17.1 |
| | 100 | 0 | 10.7 | 17.0 |
| | 100 | 100 | 10.9 | 18.4 |
| 30 μm | 0 | 0 | 10.0 | 8.7 |
| | 0 | 100 | 11.2 | 21.6 |
| | 100 | 0 | 11.0 | 19.9 |
| | 100 | 100 | 11.3 | 23.2 |

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An aligned polymer dispersed liquid crystal film comprising:
a polymer matrix; and
uniformly aligned liquid crystal droplets dispersed in the polymer matrix.

2. A method of forming an aligned polymer dispersed liquid crystal film, the method comprising in sequence:
irradiating a mixture with UV light at a first intensity to form a first composition comprising an isotropic polymer matrix, the mixture comprising:
an isotropic monomer;
a mesogenic monomer; and
a liquid crystal; and
irradiating the first composition with UV light at a second intensity to form a second composition comprising an anisotropic polymer network;
wherein the second intensity exceeds the first intensity.

3. The method of claim 2, wherein the mixture further comprises a photoinitiator.

4. The method of claim 2, wherein no voltage is applied when the mixture is irradiated with UV light at the first intensity; and wherein a curing voltage is applied when the first composition is irradiated with UV light at the second intensity.

5. The method of claim 2, wherein the first intensity is in a range of about 0.1 to about 10 mW/cm².

6. The method of claim 2, wherein the first intensity is in a range of about 0.75 to about 1.75 mW/cm².

7. The method of claim 4, wherein the curing voltage is at least 5 V.

8. The method of claim 4, wherein the curing voltage is at least 20 V.

9. The method of claim 2, wherein the mesogenic monomer is present in the mixture in an amount of at least 0.1 wt %.

10. The method of claim 2, wherein the mesogenic monomer is present in the mixture in an amount of about 2.5 to about 5 wt %.

11. A device comprising:
a quantum dot backlight; and
the aligned polymer dispersed liquid crystal film of claim 1.

12. The device of claim 11, wherein the aligned polymer dispersed liquid crystal film comprises:
a first material comprising a polymer having a refractive index nₚ; and
a plurality of droplets comprising liquid crystals disposed within the first material, the liquid crystals having an ordinary refractive index nₒ and an extraordinary refractive index nₑ.

13. The device of claim 11, wherein nₑ is at least about 1.7.

14. The device of claim 11, wherein nₑ is in the range of from about 1.6 to about 1.8.

15. The device of claim 11, wherein nₚ is in the range of from about 1.5 to about 1.6.

16. The device of claim 11, wherein nₒ is within about 0.05 of nₚ.

17. The device of claim 11, wherein the film has thickness of from about 1 μm to about 500 μm.

18. The device of claim 11, wherein the film has thickness of from about 10 μm to about 50 μm.

19. The device of claim 11, wherein the quantum dot backlight comprises a quantum dot film optically coupled to the aligned polymer dispersed liquid crystal film.

20. A method of forming an electronic device, the method comprising:
forming an aligned polymer dispersed liquid crystal film, the forming comprising in sequence:
irradiating a mixture with UV light at a first intensity to form a first composition comprising an isotropic polymer matrix, the mixture comprising:
an isotropic monomer;
a mesogenic monomer; and
a liquid crystal; and
irradiating the first composition with UV light at a second intensity to form a second composition comprising an anisotropic polymer network;
wherein the second intensity exceeds the first intensity; and
laminating the aligned polymer dispersed liquid crystal layer to a quantum dot backlight.
